(19) United States
(12) Patent Application Publication
(10) Pub. No.: US 2012/0179963 A1
(43) Pub. Date: Jul. 12, 2012

(54) MULTI-TOUCH ELECTRONIC DEVICE, GRAPHIC DISPLAY INTERFACE THEREOF AND OBJECT SELECTION METHOD OF MULTI-TOUCH DISPLAY

(76) Inventor: Wen-Hsiang CHIANG, Zhejiang (CN)

(21) Appl. No.: 12/987,577

(22) Filed: Jan. 10, 2011

(51) Int. Cl. G06F 3/041; G06F 3/01

(52) U.S. Cl. 715/702; 345/173

(57) ABSTRACT

An object selection method of a multi-touch display includes following steps: displaying a plurality of selectable objects on the multi-touch display; enabling a multi-touch mode to determine whether a first touch-control input and a second touch-control input indicate the same selectable object simultaneously; and if yes, executing a selecting operation with respective to the indicated selectable object.

### BACKGROUND OF THE INVENTION

1. Field of Invention

The present invention relates to a touch-control electronic device and an object selection method thereof, and in particular to a multi-touch electronic device and an object selection method thereof.

2. Related Art

Recently, the touch panel has been widely applied as the input device of various kinds of electronic products, such as the laptop, PDA, mobile phone and ATM. The novel touch input allows the user to directly operate the electronic product through the display panel.

As shown in FIG. 1, a conventional touch-control electronic device 1 includes a touch display 11 and a plurality of function keys 12. The touch display 11 displays a plurality of objects, which are provided to be selected by the user, or displays the result after executing the object. The function keys 12 are configured to allow the user to perform additional function operations. For example, if the user wants to select several objects displayed on the touch display 11, he/she may press one function key 12 and click the desired objects simultaneously. In brief, the touch-control electronic device 1 is unable to provide a user-friendly and simplified operation interface for the user, and it need extra space for configuring the function keys 12.

Therefore, it is an important subject to provide a multi-touch electronic device and an object selection method that can improve the operation of the multi-touch electronic device.

### SUMMARY OF THE INVENTION

In view of the foregoing subject, an objective of the present invention is to provide a multi-touch electronic device and an object selection method that can improve the operation of the multi-touch electronic device.

To achieve the above objective, the present invention discloses an object selection method of a multi-touch display including the following steps of: displaying a plurality of selectable objects on the multi-touch display; enabling a multi-touch mode to determine whether a first touch-control input and a second touch-control input indicate the same one of the selectable objects simultaneously; and if yes, executing a selecting operation with respective to the indicated selectable object.

In one aspect of the present invention, if the indicated selectable object is in a non-selected state, the selecting operation is to change the state of the indicated selectable object into a selected state. Otherwise, if the indicated selectable object is in a selected state, the selecting operation is to change the state of the indicated selectable object into a non-selected state.

In one aspect of the present invention, the object selection method further includes steps of: determining whether the multi-touch display is operated in the multi-touch mode. This step further comprises the steps of: receiving the first touch-control input; determining whether the second touch-control input is received during the period that the first touch-control input still exists; and if yes, enabling the multi-touch display to enter the multi-touch mode.

In one aspect of the present invention, the object selection method further includes steps of generating a first mean square error according to a position sequence of the first touch-control input; generating a second mean square error according to a position sequence of the second touch-control input; determining whether the first mean square error and the second mean square error are smaller than a first preset value, and whether the distance between the first touch-control input and the second touch-control input is larger than the first preset value; and if yes, generating a selection input according to the first touch-control input and the second touch-control input, wherein the selecting operation is executed with respective to the indicated selectable object according to the selection input. Otherwise, if no, the object selection method further includes steps of: generating a reference sequence according to the first touch-control input and the second touch-control input; selecting two from the reference sequence to obtain a first reference point and a second reference point; forming a selecting area according to the first reference point and the second reference point; and executing the selecting operation with respective to the indicated selectable object according to the selecting area.

To achieve the above objective, the present invention also discloses a multi-touch electronic device, which includes a multi-touch display and a computing unit. The multi-touch display displays a plurality of selectable objects, and the computing unit is coupled to the multi-touch display. When a plurality of touch-control inputs indicate one of the selectable objects simultaneously, a selecting operation is executed with respective to the indicated selectable object.

In one aspect of the present invention, the selecting operation is to change the state of the indicated selectable object into a selected state or a non-selected state.

In more specific, the selecting operation is to change the state of the indicated selectable object into a selected state when the indicated selectable object is in a non-selected state, or to change the state of the indicated selectable object into a non-selected state when the indicated selectable object is in a selected state.

To achieve the above objective, the present invention further discloses a graphic display interface of a multi-touch electronic device. The graphic display interface includes a plurality of selectable objects, which are displayed according to the states of the selectable objects. When one of the displayed selectable objects is indicated by a plurality of touch-control inputs, the state of the indicated selectable object is changed.

As mentioned above, the multi-touch electronic device and object selection method of the invention are to determine whether a plurality of touch-control inputs indicate the same selectable object simultaneously and then, if yes, to execute a selecting operation with respective to the indicated selectable object. Accordingly, the operation of the multi-touch electronic device can be improved.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional touch-control electronic device;

FIG. 2 is a schematic diagram of a multi-touch electronic device according to an embodiment of the invention;

FIG. 3 is a flow chart showing an object selection method of a multi-touch display according to an embodiment of the invention;

FIG. 4A to FIG. 4D are schematic diagrams showing the displayed content of the multi-touch display according to the embodiment of the invention; and

FIG. 5 is a schematic diagram showing a graphic display interface of a multi-touch electronic device according to an embodiment of the invention.

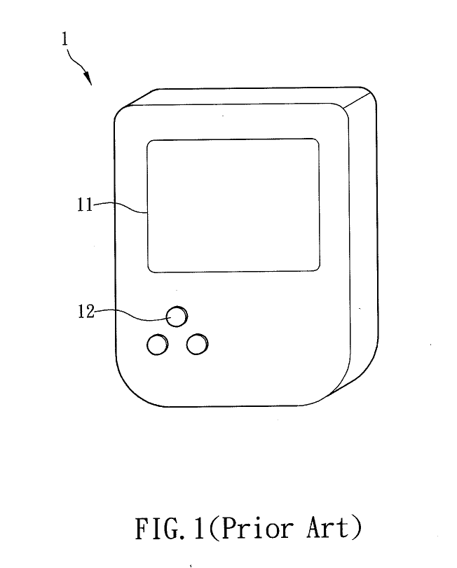

### DETAILED DESCRIPTION OF THE INVENTION

The present invention will be apparent from the following detailed description, which proceeds with reference to the accompanying drawings, wherein the same references relate to the same elements.

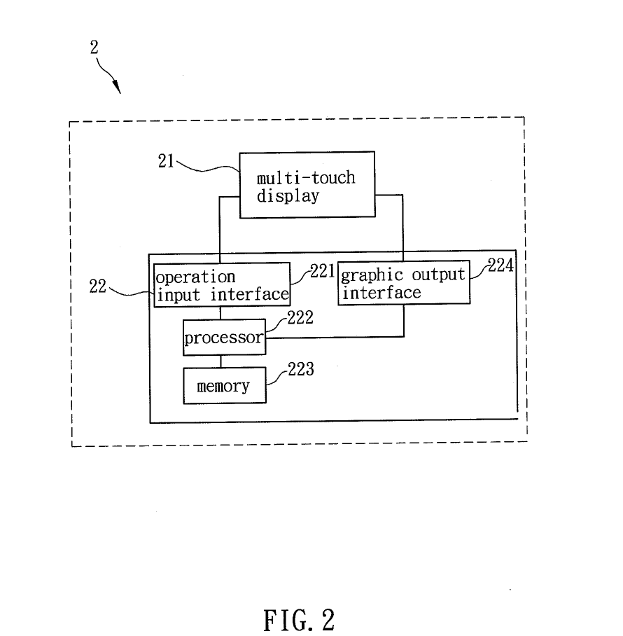

FIG. 2 is a schematic diagram of a multi-touch electronic device 2 according to an embodiment of the present invention. As shown in FIG. 2, the multi-touch electronic device 2 includes a multi-touch display 21 and a computing unit 22. In this embodiment, the multi-touch electronic device 2 can be a GPS, a wireless communication device, a PDA, a laptop computer or a desktop computer.

The multi-touch display 21 displays a plurality of selectable objects, which are provided to be selected by the user, or the results of executing the selectable objects such as pictures, text files, videos or animation. Thus, the multi-touch display 21 can display the selectable object according to the states of the selectable objects. In practice, the multi-touch display 21 can be a capacitive multi-touch display, a resistive multi-touch display, an optical multi-touch display, or an electromagnetic multi-touch display.

The computing unit 22 is coupled to the multi-touch display 21. When a plurality of touch-control inputs indicate one of the selectable objects displayed by the multi-touch display 21 simultaneously, the computing unit 22 executes a selecting operation respective to the indicated selectable object. The touch-control input is the input signal generated when the user uses his/her finger or the stylus pen to touch the multi-touch display 21. In general, the input signal represents the information of the location, the amount, the moving direction of the touch input, and the moving path of the touch input.

In this embodiment, the computing unit 22 includes an operation input interface 221, a processor 222, a memory 223 and a graphic output interface 224.

Operation input interface 221 receives the input signal generated when the user touches the multi-touch display 21. The processor 222 is coupled to the operation input interface 221 and can perform the selecting operation or other operations according to the input signal received by the operation input interface 221.

The memory 223 is coupled to the processor 222 and stores the program codes which can be executable by the processor 222. The stored program codes include the operation system (OS), drivers, applications, or the program code for carrying out the object selection method described hereinbelow.

The graphic output interface 224 is coupled to the processor 222 and outputs the operation results of the processor 222 through the multi-touch display 21. For example, the multi-touch display 21 may display the operation results as text files, videos and/or pictures.

To be noted, the above-mentioned selecting operation is to change the state of the indicated object to a selected state or a non-selected state. In more detailed, if the indicated object is in a non-selected state, the selecting operation is to change the state of the indicated object into a selected state; otherwise, if the indicated object is in a selected state, the selecting operation is to change the state of the indicated object into a non-selected state. In practice, when the selectable object is in a selected state, the frame or border of the icon of the selectable object may be displayed with a specific color, or icon of the selectable object may be shown with shadow or dots. Otherwise, when the selectable object is in a non-selected state, the icon of the selectable object may be displayed originally without showing the marked color and effects.

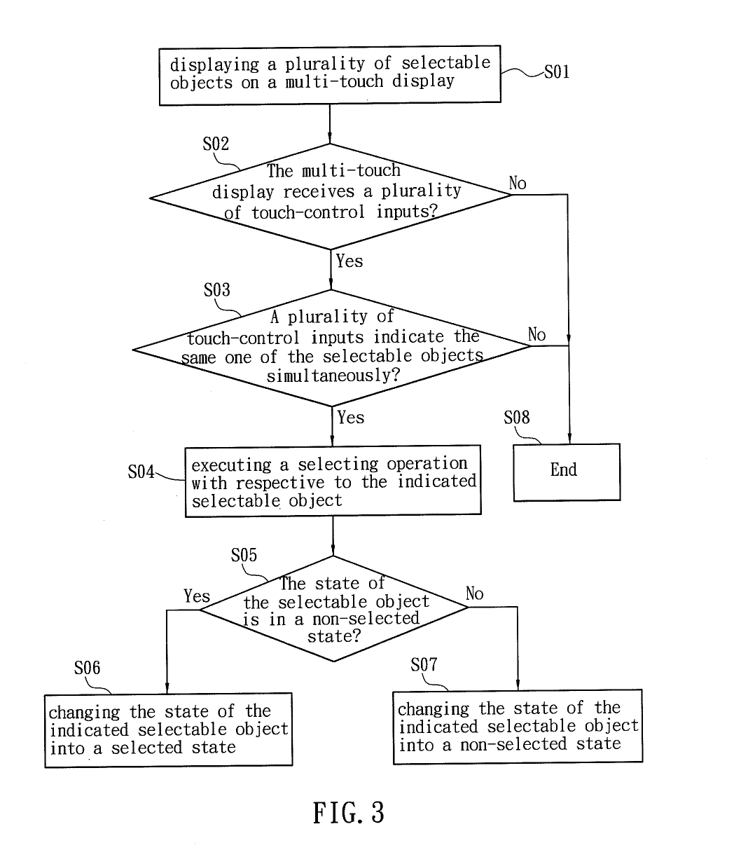

The object selection method of a multi-touch display according to the embodiment of the invention will be illustrated hereinafter with reference to the flow chart shown in FIG. 3 in view of FIG. 2. The object selection method is performed in cooperating with the above-mentioned multi-touch electronic device 2, and includes the following steps S01 to S08.

The step S01 is to display a plurality of selectable objects on a multi-touch display 21. For example, when the user desires to browse a photo database through the multi-touch electronic device 2, the multi-touch display 21 can display a plurality of selectable objects (ex. photos) for the user to select, browse or edit. To be noted, to browse the photo database is only an example of this embodiment and is not to limit the scope of the invention.

The step S02 is to determine whether the multi-touch display 21 is operated in the multi-touch mode. In practice, when the user uses his/her finger or stylus pen to touch the multi-touch display 21 to input a first touch-control input, the computing unit 22 of the multi-touch electronic device 2 can determine whether the multi-touch display 21 receives a second touch-control input during the period that the first touch-control input still exists. If the multi-touch display 21 receives the second touch-control input during the period that the first touch-control input still exists, it enters the multi-touch mode and the step S03 is then performed. On the contrary, if the multi-touch display 21 receives the second touch-control input and the first touch-control input disappears, which means only one touch-control input is generated through the multi-touch display 21, the processing procedure is ended (step S08).

To be noted, the above-mentioned first and second touch-control input are recognized based on the timings while the user touches the multi-touch display 21. In other words, the earlier touch-control input is recognized by the computing unit 22 as the first touch-control input, and the later touch-control input is recognized by the computing unit 22 as the second touch-control input. In addition, if the user touches the multi-touch display 21 and then moves on it without leaving the surface of the multi-touch display 21, these motions are recognized as the same one touch-control input.

The step S03 is to enable a multi-touch mode to determine whether the first and second touch-control inputs indicate the same one of the selectable objects simultaneously. In more detailed, when two or more touch inputs are generated simultaneously through the multi-touch display 21, the computing unit 22 further determines whether two or more touch-control inputs indicate the same one of the selectable objects simultaneously. In this embodiment, this step may be performed by determining whether two or more touch inputs reach the icon area of the selectable object simultaneously, or whether the centers of two or more touch inputs are located within the icon area of the selectable object simultaneously. If the touch inputs do not indicate the same selectable object simultaneously, the processing procedure is ended. If there are two or more touch inputs indicating the same selectable object simultaneously, the step S04 is then performed.

If the determining result of the step S03 is true, the step S04 is performed to execute a selecting operation with respective to the indicated selectable object. In this embodiment, if it is determined that there are two or more touch inputs indicating the same selectable object simultaneously, the computing unit 22 will execute a selecting operation with respective to the indicated selectable object.

The step S05 is to determine whether the state of the selectable object is in a non-selected state or not. In this embodiment, if the indicated selectable object is in a non-selected state before being indicated by two or more touch inputs, the selecting operation is to change the state of the indicated selectable object into a selected state (step S06). Otherwise, if the indicated selectable object is in a selected state before being indicated by two or more touch inputs, the selecting operation is to change the state of the indicated selectable object into a non-selected state (step S07). In practice, the computing unit 22 can mark the selectable objects in the selected state with a specific color or other vision effect, so that the selectable objects in the selected state and the selectable objects in the non-selected state can be clearly distinct from each other. Moreover, the multi-touch display 21 may display the contents of the photos 211 or provide editing functions for the user based on the states of the photos 211.

When the step S03 determines whether the first and second touch-control inputs indicate the same one of the selectable objects simultaneously, it may include the following steps. In practice, a first mean square error is generated according to a position sequence of the first touch-control input, and a second mean square error is generated according to a position sequence of the second touch-control input. Then, it is to determine whether the first mean square error and the second mean square error are smaller than a first preset value, and whether the distance between the first touch-control input and the second touch-control input is larger than the first preset value. Herein, the first preset value may be different based on the real product design.

If the determining result is yes, it means that the first and second touch-control inputs both indicate the operation of simply touching or clicking. At the meantime, the computing unit 22 of the multi-touch display 21 can generate a selecting input according to the coordinates of the first and second touch-control inputs. Herein, the selection input is the center of a line from the first touch-control input to the second touch-control input. The computing unit 22 can then perform a selecting operation to select one of the selectable objects that covers the coordinates of the selection input.

If the determining result is no, it means that the first and second touch-control inputs both indicate the operation of sliding or moving. Thus, the computing unit 22 can generate a reference sequence according to the first and second touch-control inputs, and select two from the reference sequence to obtain a first reference point and a second reference point. Herein, the first reference point and the second reference point are a start point and an end point of the reference sequence, respectively.

Then, the computing unit 22 forms a selecting area according to the first reference point and the second reference point. In practice, the computing unit 22 can form a line connecting the first and second reference points, and then use this line as a diagonal line to obtain a rectangular selecting area. Alternatively, the computing unit 22 can use this line as a diameter to obtain a circular selecting area. After that, the computing unit 22 executes the selecting operation with respective to the indicated selectable object according to the selecting area. In other words, the selectable object located in the selecting area is selected.

According to the above-mentioned object selection method as well as the corresponding hardware, the user may perform the selecting operation with respective to multiple selectable objects by a more intuitive way. Therefore, the operation and utility of the multi-touch electronic device can be improved, so that most people can easily operate it without any trouble.

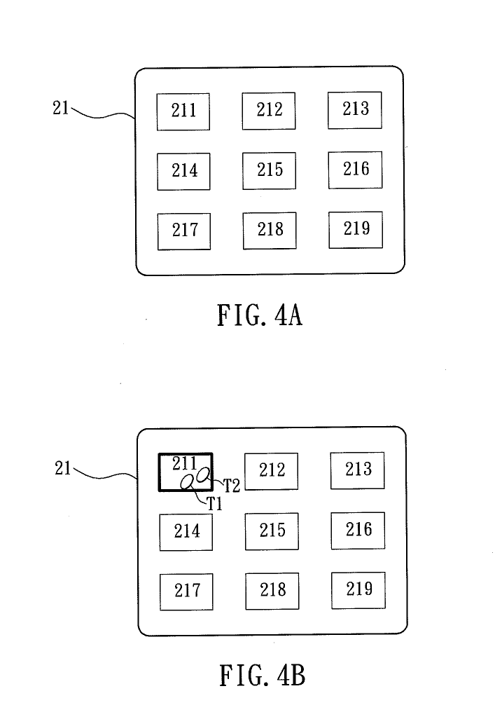

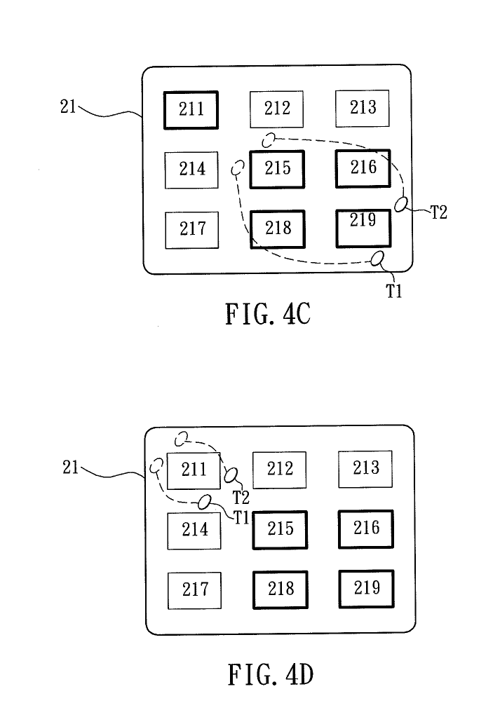

To make the object selection method of the invention more comprehensive, the displayed content of the multi-touch display 21 will be illustrated with reference to FIGS. 4A to 4D.

As shown in FIG. 4A, the multi-touch display 21 displays nine selectable objects 211 to 219. To be noted, this example of displaying nine selectable objects 211 to 219 is for illustration only and is not to limit the scope of the invention.

As shown in FIG. 4B, when a first touch input T1 and a second touch input T2 are induced on the selectable object 211 displayed on the multi-touch display 21 at the same time, the first touch input T1 and the second touch input T2 are determined as the operation of simply touching after determined and processed by the above-mentioned object selection method. In this case, the border of the indicated selectable object 211 will show a specific color after being processed according to the above-mentioned object selection method. The border with the specific color can tell the user that the selectable object 211 is in a selected state. Of course, the selectable object 211 can be marked by other visional effect. For example, the selectable object 211 of the selected state may marked with dots or shadow, so that the selectable object 211 of the selected state and the other selectable objects 212 to 219 of the non-selected state can be obviously distinct from each other.

As shown in FIG. 4C, when additional first touch input T1 and second touch input T2 are induced and slid on the multi-touch display 21, the selectable objects 215, 216, 218 and 219 located in the selected area are selected after determined and processed by the above-mentioned object selection method. In this case, the border of the indicated selectable objects 215, 216, 218 and 219 will also show a specific color. In other words, the user may continuously perform the selecting operation with respective to the selectable objects by the object selection method.

As shown in FIG. 4D, when other first and second touch inputs T1 and T2 are induced and slid on the selectable object 211 again, since the selectable object 211 is in the selected state, this selecting operation will change the state of the selectable object 219 into a non-selected state. In more detailed, the original shown visional effect (the border with the specific color) of the selected object 211 will be cancelled so as to tell the user that the selectable object 211 is in the non-selected state again.

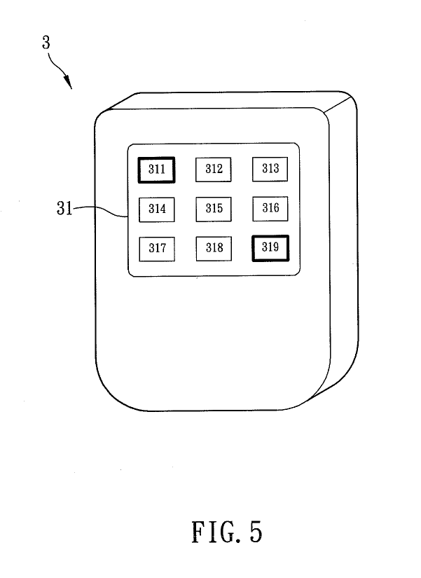

FIG. 5 is a schematic diagram showing a graphic display interface 31 of a multi-touch electronic device 3 according to the embodiment of the invention. As shown in FIG. 5, the graphic display interface 31 includes a plurality of selectable objects 311-319, and the selectable objects 311-319 are displayed according to the states thereof. When one of the displayed selectable objects 311-319 is indicated by a plurality of touch-control inputs, the state of the indicated selectable object is changed. For example, the state of the indicated selectable object is changed into a selected state when the indicated selectable object is in a non-selected state, or the state of the indicated selectable object is changed into a non-selected state when the indicated selectable object is in a selected state.

To be noted, the object selection method applied with the multi-touch electronic device 3 is the same as that of the above-mentioned multi-touch electronic device 2, so the detailed description thereof will be omitted.

In summary, the multi-touch electronic device and object selection method of the invention are to determine whether a plurality of touch-control inputs indicate the same selectable object simultaneously and then, if yes, to execute a selecting operation with respective to the indicated selectable object. Accordingly, the operation of the multi-touch electronic device can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An object selection method of a multi-touch display, comprising steps of:
displaying a plurality of selectable objects on the multi-touch display;
enabling a multi-touch mode to determine whether a first touch-control input and a second touch-control input indicate the same one of the selectable objects simultaneously; and
if yes, executing a selecting operation with respective to the indicated selectable object.

2. The method according to claim 1, wherein
if the indicated selectable object is in a non-selected state, the selecting operation is to change the state of the indicated selectable object into a selected state; and
if the indicated selectable object is in a selected state, the selecting operation is to change the state of the indicated selectable object into a non-selected state.

3. The method according to claim 1, further comprising a step of:
determining whether the multi-touch display is operated in the multi-touch mode.

4. The method according to claim 3, further comprising a step of:
receiving the first touch-control input;
determining whether the second touch-control input is received during the period that the first touch-control input still exists; and
if yes, enabling the multi-touch display to enter the multi-touch mode.

5. The method according to claim 1, wherein the multi-touch display displays the selectable objects according to the states of the selectable objects.

6. The method according to claim 1, further comprising steps of:
generating a first mean square error according to a position sequence of the first touch-control input;
generating a second mean square error according to a position sequence of the second touch-control input;
determining whether the first mean square error and the second mean square error are smaller than a first preset value, and whether the distance between the first touch-control input and the second touch-control input is larger than the first preset value; and
if yes, generating a selection input according to the first touch-control input and the second touch-control input, wherein the selecting operation is executed with respective to the indicated selectable object according to the selection input.

7. The method according to claim 6, wherein the selection input is located at the center of a line from the first touch-control input and the second touch-control input.

8. The method according to claim 6, further comprising steps of:
if no, generating a reference sequence according to the first touch-control input and the second touch-control input;
selecting two from the reference sequence to obtain a first reference point and a second reference point;
forming a selecting area according to the first reference point and the second reference point; and
executing the selecting operation with respective to the indicated selectable object according to the selecting area.

9. The method according to claim 8, wherein the first reference point and the second reference point are a start point and an end point of the reference sequence, respectively.

10. A multi-touch electronic device, comprising:
a multi-touch display for displaying a plurality of selectable objects; and
a computing unit coupled to the multi-touch display, wherein when a plurality of touch-control inputs indicate one of the selectable objects simultaneously, a selecting operation is executed with respective to the indicated selectable object.

11. The multi-touch electronic device according to claim 10, wherein the selecting operation is to change the state of the indicated selectable object into a selected state or a non-selected state.

12. The multi-touch electronic device according to claim 11, wherein the selecting operation is to change the state of the indicated selectable object into a selected state when the indicated selectable object is in a non-selected state, or to change the state of the indicated selectable object into a non-selected state when the indicated selectable object is in a selected state.

13. The multi-touch electronic device according to claim 10, wherein the multi-touch display displays the selectable objects according to the states of the selectable objects.

14. A graphic display interface of a multi-touch electronic device, comprising:
a plurality of selectable objects, wherein the selectable objects are displayed according to the states of the selectable objects,
wherein when one of the displayed selectable objects is indicated by a plurality of touch-control inputs, the state of the indicated selectable object is changed.

15. The graphic display interface according to claim 14, wherein the state of the indicated selectable object is changed into a selected state when the indicated selectable object is in a non-selected state, or the state of the indicated selectable object is changed into a non-selected state when the indicated selectable object is in a selected state.
